(19) United States
(12) Patent Application Publication
(10) Pub. No.: US 2021/0031494 A1
(43) Pub. Date: Feb. 4, 2021

(54) METHOD FOR PRODUCING A COMPOSITE PANE HAVING POLARISATION-SELECTIVE COATING

(71) Applicant: SAINT-GOBAIN GLASS FRANCE, COURBEVOIE (FR)

(72) Inventors: Martin ARNDT, AACHEN (DE); Michele CAPPUCCILLI, MONSCHAU (DE); Ali-Osman KIZMAZ, WÜRSELEN (DE); Harald STOFFEL, ALSDORF (DE); Uwe VAN DER MEULEN, NIDEGGEN (DE)

(21) Appl. No.: 16/978,592

(22) PCT Filed: Apr. 29, 2019
(86) PCT No.: PCT/EP2019/060841

§ 371 Date: Sep. 4, 2020

(30) Foreign Application Priority Data
Jun. 21, 2018 (EP) 18178923.1

(51) Int. Cl. B32B 17/10

(52) U.S. Cl. CPC B32B 17/10036; B32B 17/10788; B32B 17/1077; B32B 2605/006; B32B 17/10293; B32B 17/10504; B32B 2329/06; B32B 17/10174

(57) ABSTRACT

A method for producing a composite pane suitable as a projection surface of a projection assembly, wherein (a) a polarisation-selective coating is provided on a carrier film; (b) the polarisation-selective coating is transferred from the carrier film onto a laminating film, by (i) arranging the carrier film and the laminating film areally one atop the other with the coating positioned therebetween to form a film stack, (ii) treating the film stack for at least 2 hours at a pressure of at least 8 bar and a temperature of 80° C. to 120° C. in an autoclave, and (iii) peeling the carrier film off the laminating film, with the coating remaining on the laminating film; (c) the laminating film is arranged areally between a first pane and a second pane; and (d) the first pane is laminated with the second pane via the laminating film to form the composite pane.

The invention relates to a method for producing a composite pane that is suitable as a projection surface of a projection assembly as well as a method for producing such a projection assembly.

Modern automobiles are increasingly equipped with so-called head-up displays (HUDs). With a projector, for example, in the region of the dashboard or in the roof region, images are projected onto the windshield, reflected there, and perceived by the driver as a virtual image (from his point of view) behind the windshield. Thus, important data can be projected into the driver's field of vision, for example, the current driving speed, navigation or warning messages, which the driver can perceive without having to divert his glance from the road. Head-up displays can thus contribute significantly to an increase in traffic safety.

With the most common HUDs, the windshield is irradiated with s-polarised radiation which is reflected to a large extent by the glass surfaces. The problem arises that the projector image is reflected on both surfaces of the windshield. Thus, the driver perceives not only the desired primary image but also a slightly offset secondary image. The latter is commonly referred to as a ghost image. This problem is usually solved in that the reflecting surfaces are arranged at an angle relative to one another deliberately selected such that the primary image and the ghost image coincide, as a result of which the ghost image is no longer distractingly noticeable. Windshields are implemented as composite panes and the angle is introduced most simply through the use of a wedge-shaped thermoplastic intermediate layer between the two glass panes. Composite glasses for a head-up displays with wedge films are known, for example, from EP1800855B1 or EP1880243A2.

Alternatively, HUDs are also known in which the windshield is irradiated with p-polarised radiation. Since the typical angle of incidence is near Brewster's angle for an air-gas transition, p-polarised radiation is not significantly reflected and the problems of ghost images are thus avoided. As a necessary reflection surface for the radiation, a reflecting film that is, for example, laminated into the intermediate layer of the composite pane is provided instead. Such a HUD is known, for example, US2004135742A1. The reflecting film should, in particular, efficiently reflect p-polarised radiation and reflect s-polarised radiation only to a small extent to improve optical quality such that polarisation-selective coatings are, in particular, suitable for the reflecting films.

Known from US2010157426A1 is a polarisation-selective coating as well as a method, as to how this coating can be introduced into a composite pane. The coating is provided on a carrier film and then transferred onto a laminating film that is laminated between two glass panes. In the transfer of the coating, the carrier film is pressed with the coated side under interposition of an adhesive layer, wherein the film stack is under load for 2 hours at a temperature of 50° C. with 0.5 kg. However, it has been demonstrated that this method only yields a relatively weak bond between the polarisation-selective coating and the laminating film. This can lead to problems if the windshield is to be provided with the coating over a large area. In addition, it has been demonstrated that the process is not robust enough to be able to be used without major adaptation of the parameters to laminating films of different types and different thicknesses.

The polarisation-selective coating of US2010157426A1 includes rod-shaped nanoparticles (so-called “nanorods”), with the polarisation-selective reflection behaviour achieved through the orientation of the rods. An alternative implementation of polarisation-selective coatings is based on cholesteric liquid crystals, as described, for example, in JP4208990B2.

Consequently, there is a need for improved methods for producing composite panes with polarisation-selective coatings. The object of the invention is to provide such an improved method. In particular, the polarisation-selective coating should be reliably and stably transferred from a carrier film onto a laminating film and the resultant composite pane should have high optical quality.

The object of the present invention is accomplished according to the invention by a method in accordance with claim 1. Preferred embodiments are apparent from the dependent claims.

The method according to the invention serves for producing a composite pane that is suitable and is provided as a projection surface of a projection assembly. First, a polarisation-selective coating is provided on a carrier film. The polarisation-selective coating is subsequently transferred from the carrier film onto a laminating film. The laminating film with the polarisation-selective coating is then arranged areally between a first pane and a second pane. Then, the first pane is laminated with the second pane via the laminating film to form the composite pane.

Polarisation-selective coatings are typically provided on carrier films that have no hot melt adhesive properties and, consequently, cannot be used to laminate two glass panes to form a composite pane. Polarisation-selective coatings are even commercially available on such carrier films, in particular films made of polyethylene terephthalate (PET). In principle, it is certainly conceivable to laminate the carrier film in the intermediate layer of the composite pane between two hot melt adhesive films; however, it has become apparent that this does not yield satisfactory results: the high stiffness of typical carrier films results in wrinkling in the composite pane customarily bent for vehicle applications such that it does not meet the optical requirements. Consequently, it is necessary to transfer the coating from the carrier film onto a laminating film that is flexible and can be used as a hot melt adhesive film for joining the glass panes.

The advantages of the invention reside in particular in the transfer of the polarisation-selective coating from the carrier film onto the laminating film. The method according to the invention results in a strong bond between the coating and the laminating film, as a result of which, in particular, even the coating of large area regions of the laminating film as possible. In addition, laminating films of different types and different thicknesses are compatible with the method.

The laminating films with the coating have high optical quality, and the coated laminating films are suitable for being used as a thermoplastic intermediate films for composite panes of high optical quality. The composite panes produced according to the invention meet the high requirements set for windshields such that they can be used as such.

The transfer of the polarisation-selective coating according to the invention is done by
arranging the carrier film and the laminating film one atop the other with the coating positioned areally therebetween to form a film stack,
treating the film stack subsequently for at least 2 hours at a pressure of at least 8 bar and a temperature of 80° C. to 120° C. in an autoclave, and
peeling the carrier film thereafter off the laminating film, with the coating remaining on the laminating film.

Carrier films with polarisation-selective coatings are commercially available, for example, on rolls or as film sheets. The step of providing the polarisation-selective coating on the carrier film preferably starts from such a purchased roll or sheet and includes trimming a film section to the desired size and shape. Ideally, the desired size and shape corresponds to the size and shape of the region of the laminating film that is to be provided later with the polarisation-selective coating. In principle, the polarisation-selective coating can, however, also be applied on the cut-to-size carrier film, for example, by brushing on and drying a solution of the anisotropic units and, optionally, subsequent stretching.

During arrangement of the carrier film and the laminating film to form the film stack, the polarisation-selective coating is brought into contact with the laminating film. The laminating film is preferably trimmed in advance to the desired size and shape, which substantially corresponds to the size and shape of the glass panes to be laminated. However, it is, in principle, also possible to carry out the transfer of the coating onto a larger section of the laminating film and then to trim a piece thereof to the desired size and shape.

If the entire (trimmed-to-size) laminating film is to be provided with the polarisation-selective coating, the laminating film and the carrier film are preferably congruent and are arranged completely overlapping one another such that the entire surface of the laminating film is brought into contact with the coating. Alternatively, the carrier film can also have a larger area than the laminating film such that it protrudes partially or circumferentially beyond the edges of the laminating film. It is thus also achieved that the entire surface of the laminating film is brought into contact with the coating, and, possibly, a better quality of coating edges can be obtained on the laminating film; however, this approach is associated with material waste. If, on the other hand, only one region of the laminating film is to be provided with the polarisation-selective coating, the trimmed-to-size carrier film has a smaller area than the trimmed-to-size laminating film and is placed on the laminating film such that said region is brought completely into contact with the coating.

The handling of the films, i.e., the arrangement of the carrier film and the laminating film to form the film stack and preferably also the trimming of the films is preferably done under clean room conditions, thus reducing the risk of contaminants, which could, in particular, adversely affect the optical quality. In the context of the invention, “clean room conditions” means conditions wherein the ambient air contains at most 352,000 particles with a size greater than 0.5 μm per cubic meter. The temperature in the clean room is preferably 15° C. to 25° C. and the relative humidity is preferably less than 30%.

The carrier film is typically made of or based on a thermoplastic material that has no hot melt adhesive properties. This means, in particular, hot melt adhesive properties relative to glass surfaces at typical lamination temperatures of approx. 130° C. Preferably, the carrier film includes or is substantially made of polyethylene terephthalate (PET), as is also customary for commercially available carrier films. The carrier film preferably has a thickness of 30 μm to 500 μm, particularly preferably of 50 μm to 200 μm, for example, approx. 100 μm.

The laminating film is typically made of or based on a thermoplastic material with hot melt adhesive properties (under the above-mentioned conditions). Preferably, the laminating film includes or is substantially made of polyvinyl butyral (PVB), ethylene vinylacetate (EVA), polyurethane (PU), or mixtures or copolymers or derivatives thereof, preferably PVB. These materials are customary for the lamination of composite glasses. The laminating film can also include plasticisers, stabilisers, colorants, or other additives. The laminating film preferably has a thickness of 0.1 mm to 2 mm, particularly preferably of 0.3 mm to 1 mm, for example, the standard thicknesses of approx. 0.38 mm or 0.76 mm.

The two surfaces of commercially available laminating films typically have a different roughness, for production related reasons. The laminating film thus has one surface with lower roughness and an opposite surface with higher roughness. For the adhesion of the coating on the laminating film, it is advantageous for the coating to be brought into contact with the surface with lower roughness. Consequently, during arrangement of the carrier film and the laminating film to form the film stack, the surface with lower roughness is turned toward the carrier film (and the coating). The surface with lower roughness preferably has an average roughness depth Rz less than 25 μm; and the surface with higher roughness, an average roughness depth Rz greater than 25 μm. The surface with lower roughness particularly preferably has an average roughness depth Rz of 5 μm to 20 μm; and the surface with higher roughness, an average roughness depth Rz of 30 μm to 50 μm.

The film stack is treated in an autoclave, wherein the bond of the polarisation-selective coating to the laminating film is produced. The processing parameters are critical for ensuring a stable bond without optical distortions. In particular, the temperature must not be selected excessively high, because, otherwise, cracks can develop in the coating. According to the invention, the temperature is from 80° C. to 120° C., preferably from 85° C. to 115° C., particularly preferably from 90° C. to 110° C., for example, approx. 100° C. The duration of the autoclave treatment is, according to the invention, at least 2 hours, preferably from 2 hours to 4 hours, for example, approx. 2.5 hours. In the autoclave, the film stack is exposed to a pressure of at least 8 bar, preferably from 8 bar to 15 bar, for example, approx. 12 bar.

During the autoclave treatment, the film stack is preferably arranged between two plates (pressing plates), which press the laminating film and the carrier film against one another. For example, the two plates can be connected to one another via bolts, by means of which their mutual distance and, thus, the pressure on the film stack can be regulated. The plates can, for example, be made of a metal or a plastic (such as polycarbonate or PMMA) and have a thickness from 1 cm to 4 cm. The plates ensure that the pressure in the autoclave is uniformly distributed over the film stack.

Before the treatment in the autoclave, the stack is preferably subjected to negative pressure in order to deaerate the intermediate space between the laminating film and the panes. This is done, for example, using the vacuum bag or vacuum ring methods known per se.

After bonding in the autoclave, the carrier film is peeled off the laminating film, with the coating remaining on the laminating film. It is advisable to start from a corner of the carrier film and then peel the carrier film with uniform speed in order to ensure the highest possible optical quality of the coating on the laminating film. The peeling should be done sufficiently slowly and carefully overall in order not to produce marks on the coating.

Immediately after removal from the autoclave, the film stack is possibly still too hot to peel off the carrier film without damage or adverse effects on optical quality. Consequently, it is advisable to first let the film stack cool or to actively cool it. However, excessively intense cooling to room temperature is, on the other hand, detrimental to the detachment of the carrier film. During the peeling of the carrier film, the temperature of the film stack should ideally be from 30° C. to 65° C.

When the polarisation-selective coating is transferred onto the laminating film, the latter can be used to bond the first and the second pane to one another to form the composite pane. The first pane, the laminating film, and the second pane are arranged areally and substantially congruently atop one another and then bonded to one another under the action of temperature, pressure, or vacuum and, thus, laminated to form the composite pane.

The laminating film and, with it, the polarisation-selective coating is arranged between the panes here and in the subsequent composite pane such that it significantly reflects radiation incident on the composite pane in a p-polarising manner. The reflectance of the coating for p-polarised radiation is thus substantially maximised. Since the laminating film has to be arranged congruent with the panes and, consequently, there are no degrees of freedom with regard to its orientation (at least when the laminating film is already trimmed to size), the orientation of the coating must already be taken into account during its transfer from the carrier film to the laminating film.

The lamination is again preferably done in an autoclave. Here, as well, the temperature should not be excessively high: at otherwise customary lamination temperatures of approx. 130° C., cracks in the polarisation-selective coating can occur. The temperature is preferably less than 130° C., particularly preferably at most 100° C. The duration of the autoclave treatment is preferably from 2 hours to 4 hours, for example, approx. 3 hours. Alternatively, however, in principle, other methods known per se, such as vacuum bag methods, vacuum ring methods, calender methods, or vacuum laminators, can be used.

In one embodiment, an additional laminating film can be placed on the polarisation-selective coating such that the coating is arranged in the composite pane between two layers of the thermoplastic material and is, so to speak, encapsulated.

Alternatively, the polarisation-selective coating can be brought into direct contact with the first or second pane. This is even preferable, since it has been shown that, in this way, waviness of the coating (a so-called “orange-peel effect”) can be reduced. The interposed coating does not significantly impair the adhesion of the pane in question on the laminating film. Preferably, the laminating film with the polarisation-selective coating according to the invention is the only film that is arranged for lamination between the panes such that the intermediate layer of the finished composite pane is formed by this laminating film alone.

The first pane and the second pane are preferably made of glass, in particular soda lime glass. However, the panes can, in principle, also be made of other types of glass, such as quartz glass or borosilicate glass, or even rigid clear plastics, in particular polycarbonate (PC) or polymethyl methacrylate (PMMA). The materials for the first and the second pane can be selected independently of one another. Thus, it is, for example, conceivable to laminate a pane made of soda lime glass with a PC pane to form the composite pane.

Since the composite pane is provided in particular as a window pane and as such, in a window opening of an interior, in particular separates the interior of a vehicle from the external environment, the first and the second pane can also be referred to as “inner pane” and “outer pane”. The pane of the composite pane facing the interior (vehicle interior) is referred to as the “inner pane”. The pane facing the external environment is referred to as the “outer pane”. The polarisation-selective coating preferably faces the inner pane.

The composite pane is typically curved in one or a plurality of spatial directions, as is common in the automotive sector. For this, the first and the second pane are subjected to a bending process prior to lamination, for example, by means of gravity bending, press bending, or suction bending. Typical temperatures for glass bending processes are, for example, 500° C. to 700° C.

The panes and the laminating film can, independently of one another, be clear and colourless, but also tinted or coloured. The total transmittance through the composite pane is, in a preferred embodiment, greater than 70%. The term “total transmittance” is based on the the process defined by ECE-R 43, Annex 3, § 9.1 for testing light permeability of motor vehicle windows.

The polarisation-selective coating according to the invention can be implemented in various ways. The polarisation-selective coating typically includes anisotropic particles or units. The polarisation-selective effect is achieved through the orientation order of the anisotropic units, which can, for example, be adjusted by stretching the carrier film. The anisotropic particles or units can, for example, be metallic nanorods, as disclosed in US2010157426A1, by way of example. In a preferred embodiment, the polarisation-selective coating includes liquid crystals, in particular liquid crystals in a nematic phase, wherein the molecules have an orientation order relative to a so-called director of the direction, the unit vector. Particularly preferably, the polarisation-selective coating includes liquid crystals in a cholesteric phase. The cholesteric phase is a special case of the nematic phase, which has a nematic order with a continuously rotating preferred orientation. This yields a long helical superstructure. The cholesteric phase makes it possible, in particular, to adjust and to optimise the reflection properties of the coating as a function of wavelength. Thus, a reflection spectrum of the coating can be produced, wherein specific wavelengths or specific relatively narrow wavelength ranges can be reflected selectively, whereas the remaining wavelength ranges are reflected only to a very small extent. The coating can thus be optimized to the wavelengths with which they are irradiated for producing the projection, wherein interfering reflections that would stem from other wavelengths are avoided.

In an advantageous embodiment, the coating is adjusted such that the reflection bands cover the wavelengths 473 nm, 550 nm, and 630 nm. Particularly preferably, the local reflection maxima are situated at or near these wavelengths, whereas reflection minima or plateaus with lower reflection are situated between said reflection maxima. The wavelengths indicated correspond to the colours red, green, and blue (RGB) of typical projectors for producing display images on composite panes, as they are in particular common for HUDs.

The laminating film can be provided with the polarisation-selective coating over its entire area. Alternatively, only one region of the laminating film can be provided with the coating. In one advantageous embodiment, the first pane and/or the second pane have a masking print that conceals the side edges of the polarisation-selective coating in through-vision through the composite pane after lamination. This is in particular advantageous when only one region of the laminating film is provided with the coating because the side edge of the coating would then be distractingly noticeable. Preferably, both panes are provided with a masking print such that the side edge is discernible neither from the outside nor from the inside. Masking prints are common for vehicle window panes and are typically formed by a substantially opaque enamel that is printed and fired onto the panes before lamination, using the screen printing method in particular.

The polarisation-selective coating is arranged at least in one irradiation region of the composite pane that is provided to be irradiated by a projector in order to generate a display image.

The composite pane produced according to the invention is preferably provided as a vehicle window pane, in particular as a windshield. Windshields have a central field of vision, for which high optical quality requirements are established. The central field of vision has to have high light transmittance (typically greater than 70%). Said central field of vision is, in particular, that field of vision that is referred to by the person skilled in the art as field of vision B, vision area B, or zone B. The field of vision B and its technical requirements are specified in Regulation No. 43 of the United Nations Economic Commission for Europe (UN/ECE) (ECE-R43, “Uniform Provisions concerning the Approval of Safety Glazing Materials and Their Installation on Vehicles”). The field of vision B is defined in Appendix 18.

In one embodiment of the invention, the polarisation-selective coating substantially covers the central field of vision B of the windshield. The composite pane can, for example, be provided with the coating over its entire area or over its entire area, minus a surrounding, peripheral edge region of a width of as much as 10 cm, in order to protect the coating against contact with the surrounding atmosphere. The side edges of the coating are then covered by the surrounding peripheral masking print that is common for windshields. With this, a so-called “contact analogous HUD” or “augmented reality HUD (AR-HUD)” can advantageously be realised. In a contact analogous HUD, not only is information projected onto a limited region of the windshield, but elements of the external surroundings are included in the display. Examples of this are the labeling of a pedestrian, the display of the distance to a preceding vehicle, or the projection of navigation data directly on the roadway, for example, for marking the traffic lane to be selected. Contact analogous HUD is distinguished from a conventional, statistical HUD in that the projection distance is at least 5 m. In a statistical HUD, the projection distance is significantly less, typically approx. 2 m. In the context of the invention, “projection distance” refers to the distance between the virtual image and the observer, i.e., usually the driver's head. The projection distance is preferably at least 7 m. The projection distance is preferably at most 15 m.

In another embodiment of the invention, the polarisation-selective coating is arranged outside a central field of vision B of the windshield. With this, a projection area can be realised in the edge region of the windshield, in which any information desired can be displayed for the observer. Such a projection area can, for example, be used for entertainment or infotainment, for instance, for watching films, navigation data, or the labeling of or commenting on objects in the surroundings. Outside the field of vision B, there are lower requirements for vision through the pane such that, here, a masking print can be arranged to conceal the side edges of the coating.

The composite pane produced according to the invention is preferably used as a window pane of a vehicle, particularly preferably as a windshield. The composite pane is part of a projection assembly and serves as a projection area. The projection assembly includes the composite pane and a projector, which is aimed at a region (projection region) of the composite pane. The projection assembly can be provided for a HUD, in particular an AR-HUD, or even for displaying any other data.

The invention also includes, starting from the production of the composite pane according to the invention, the production of a projection assembly, including the production of a composite pane according to the method according to the invention and subsequent arrangement of a projector relative to the composite pane such that the polarisation-selective coating can be irradiated. The relative arrangement of the composite pane and the projector is done in particular during installation of the elements in a vehicle. The projector preferably emits p-polarisierte radiation and irradiates the polarisation-selective coating therewith. The projector irradiates the composite pane preferably with an incident angle (angle relative to the surface normal) from 60° to 70°, in particular approx. 65°, as is also common for current HUDs. This angle of incidence is relatively near Brewster's angle for an air-gas transition (57.2°, soda lime glass) such that the p-polarised radiation is hardly reflected by the pane surface. The occurrence of ghost images can thus be minimised or completely avoided.

In the following, the invention is explained in detail with reference to drawings and exemplary embodiments. The drawings are schematic representations and are not true to scale. The drawings in no way restrict the invention.

They depict:

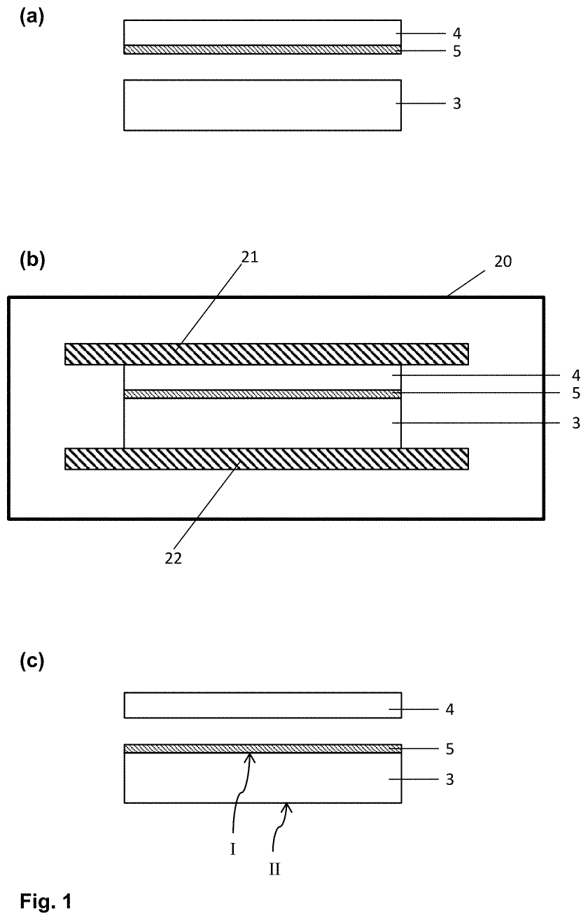

FIG. 1 a cross-section through the carrier film and the laminating film during the transfer of the polarisation-selective coating from the carrier film onto the laminating film,

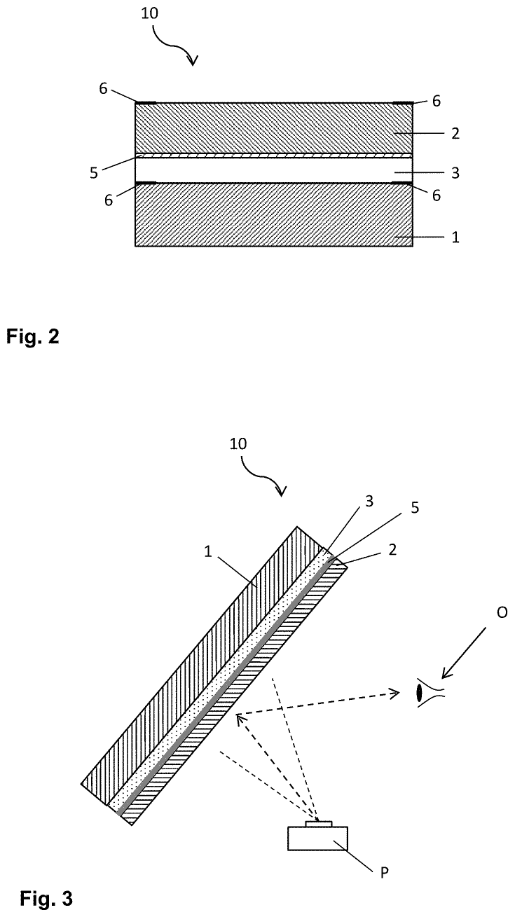

FIG. 2 a cross-section through a composite pane produced according to the invention,

FIG. 3 a cross-section through a projection assembly produced according to the invention,

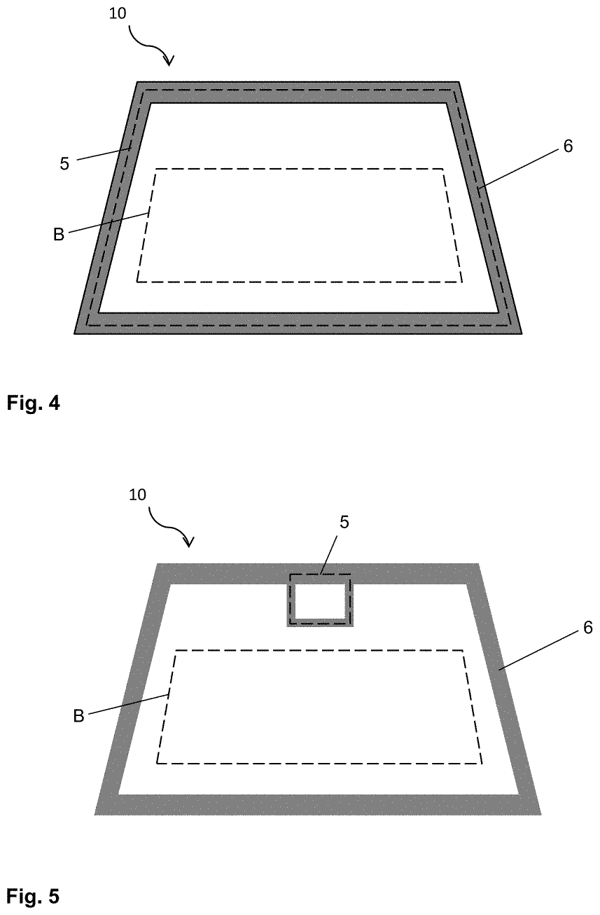

FIG. 4 a plan view of an embodiment of the composite pane produced according to the invention,

FIG. 5 a plan view of another embodiment of the composite pane produced according to the invention, and

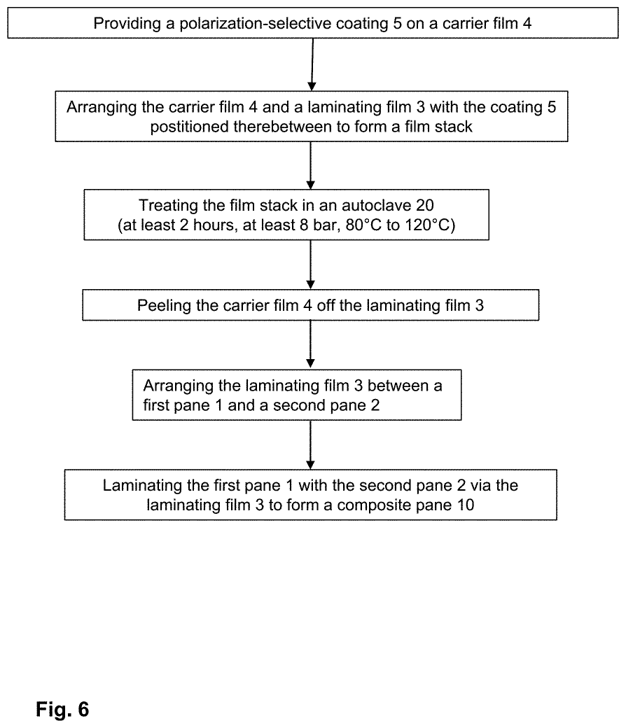

FIG. 6 a flowchart of an embodiment of the method for producing a composite pane according to the invention.

FIG. 1 depicts cross-sections at three points in time during the transfer of a polarisation-selective coating 5 from a carrier film 4 onto a laminating film 3. The polarisation-selective coating 5 includes, for example, liquid crystals in a cholesteric phase and was commercially acquired applied on a carrier film 4 made of PET (thickness 100 μm). Since the PET film is very stiff and has no hot melt adhesive properties relative to the glass surfaces at typical lamination temperatures, it cannot be used as an intermediate layer of a composite pane. In order to produce a composite pane of high optical quality, it is, consequently, necessary to transfer the coating 5 onto a laminating film 3, for example, a PVB film with a thickness of 0.76 mm.

In the initial state, the carrier film 4 provided with the coating 5 and the uncoated laminating film 3 are present (Part a). The carrier film 4 and the laminating film 3 are arranged one atop another with the coating 5 areally positioned therebetween to form a film stack, pressed against one another by means of a first pressing plate 21 and a second pressing plate 22 and treated in an autoclave (Part b). The films 4, 3, already trimmed to their final shape, have, for example, dimensions of approx. 1.1 m×1.7 m. Suitable processing parameters in the autoclave are a pressure of 12 bar, a temperature of 100° C., and a treatment duration of 2.5 hours. The film stack is then removed from the autoclave and allowed to cool to a temperature of, for example, 40° C. Then, the carrier film 4 is carefully peeled off starting from one corner and the coating 5 remains on the laminating film 3 (Part c). As is customary for PVB films, the laminating film 3 has one surface II with higher roughness and one surface I with lower roughness. The coating 5 is applied on the surface I, as a result of which better adhesion is achieved.

FIG. 2 depicts a cross-section of a composite pane 10 produced according to the invention. It comprises a first pane 1 made of soda lime glass with a thickness of, for example, 2.1 mm and a second pane 2 made of soda lime glass with a thickness of, for example, 1.6 mm, that are bonded to one another via a laminating film 3 provided with the polarisation-selective coating 5. The coating 5 is directed toward the second pane 2. The surface of the first pane 1 facing the laminating film 3 as well as the surface of the second pane 2 facing away from the laminating film 3 are provided with a surrounding, peripheral masking print 6, as is common for window panes for vehicles. The masking print 6 conceals the side edges of the coating 5.

FIG. 3 depicts a cross-section of the composite pane 10 of FIG. 2 as a projection surface of a projection assembly. The composite pane 10 is the windshield of a motor vehicle. The first pane 1 is, in this case, the outer pane; the second pane 2, the inner pane. It is irradiated by a projector P with p-polarised radiation at an angle of approx. 65°. The p-polarised radiation is hardly reflected by the surface of the panes 1, 2, but is very efficiently reflected by the polarisation-selective coating 5. This creates a projection that an observer O, for example, the driver of the vehicle can perceive.

FIG. 4 depicts a plan view of an embodiment of the composite pane 10 produced according to the invention. The composite pane 10 is the windshield of a motor vehicle and has a field of vision B per ECE-R43. It is provided with the polarisation-selective coating 5 over its full surface, minus a surrounding edge region with a width of a few centimeters. Consequently, the coating 5 completely covers the field of vision B. The side edges of the coating 5 are concealed by the masking print 6. This embodiment is particularly suitable as a projection surface for a contact-analog augmented reality HUD. Projections can be produced on the entire pane and the environment can be included in the display. It is thus possible, for example, to project an arrow such that it apparently lies on a traffic lane and marks this for the driver.

FIG. 5 depicts a plan view of another embodiment of the composite pane 10 produced according to the invention. The composite pane 10 is likewise the windshield of a motor vehicle and has a field of vision B per ECE-R43. Only a relatively small region of the composite pane 10 is provided with the polarisation-selective coating 5, which region is located completely outside the field of vision B. Any data desired by the observer can be displayed there. An additional masking print 6 can be arranged outside the field of vision B to conceal the side edges of the coating B.

FIG. 6 depicts a flowchart of an exemplary embodiment of the method for producing a composite pane according to the invention.

### LIST OF REFERENCE CHARACTERS

(10) composite pane
(1) first pane
(2) second pane
(3) laminating film
(4) carrier film
(5) polarisation-selective coating
(6) masking print
(20) autoclave
(21) first pressing plate
(22) second pressing plate
(I) surface of the laminating film 3 with lower roughness
(II) surface of the laminating film 3 with higher roughness
(P) projector
(O) observer/vehicle driver
(B) central field of vision of the composite pane 10

1. A method for producing a composite pane that is suitable as a projection surface of a projection assembly, the method comprising:
(a) providing a polarisation-selective coating on a carrier film;
(b) transferring the polarisation-selective coating from the carrier film onto a laminating film, by
(i) arranging the carrier film and the laminating film areally one atop the other with the polarisation-selective coating positioned therebetween to form a film stack,
(ii) treating the film stack for at least 2 hours at a pressure of at least 8 bar and a temperature of 80° C. to 120° C. in an autoclave, and
(iii) peeling the carrier film off the laminating film, with the polarisation-selective coating remaining on the laminating film;
(c) areally arranging the laminating film between a first pane and a second pane; and
(d) laminating the first pane with the second pane via the laminating film to form the composite pane.

2. The method according to claim 1, wherein the polarisation-selective coating (5) includes liquid crystals.

3. The method according to claim 1, wherein the carrier film includes polyethylene terephthalate (PET).

4. The method according to claim 1, wherein the laminating film contains polyvinyl butyral (PVB), ethylene vinylacetate (EVA), polyurethane (PU), or mixtures or copolymers or derivatives thereof.

5. The method according to claim 1, wherein the laminating film has one surface with lower roughness and one surface with higher roughness, and wherein in step (i), the surface with lower roughness is turned toward the carrier film.

6. The method according to claim 1, wherein in step (ii), the film stack is arranged between two pressing plates.

7. The method according to claim 1, wherein in step (iii), the temperature of the film stack is from 30° C. to 65° C.

8. The method according to claim 1, wherein the polarisation-selective coating is arranged in direct contact with the first or second pane.

9. The method according to claim 1, wherein the first pane and/or the second pane has a masking print that conceals side edges of the polarisation-selective coating after lamination.

10. The method according to claim 1, wherein the composite pane is a windshield and the polarisation-selective coating substantially covers the central field of vision B per ECE-R43.

11. The method according to claim 1, wherein the composite pane is a windshield and the polarisation-selective coating is arranged outside the central field of vision B per ECE-R43.

12. The method according to claim 1, wherein in step (d), the lamination is carried out in an autoclave at a temperature of less than 130° C.

13. The method according to claim 1, wherein the polarisation-selective coating is arranged in the composite pane such that its reflectance for p-polarised radiation is maximised.

14. A method for producing a projection assembly, comprising:
(a) producing a composite pane according to the method according to claim 1;
(b) arranging a projector such that the polarisation-selective coating can be irradiated.

15. The method according to claim 14, wherein the projector irradiates the polarisation-selective coating with p-polarised radiation.

16. The method according to claim 2, wherein the liquid crystals are in a cholesteric phase.

17. The method according to claim 4, wherein the laminating film contains polyvinyl butyral (PVB).

18. The method according to claim 12, wherein in step (d), the temperature is at most 100° C.
